(19) United States
(12) Patent Application Publication
(10) Pub. No.: US 2003/0084228 A1
(43) Pub. Date: May 1, 2003

(54) Parametring and automatic compilation of structures using standard representation networks

(76) Inventors: Bernard Hautbergue, Joinville Le Point (FR); Emmanuel Benoit, Merris (FR); Stephane Donders, Paris (FR)

Correspondence Address: CHRISTIE, PARKER & HALE, LLP, P.O. BOX 7068, PASADENA, CA, 91109-7068, US

(21) Appl. No.: 10/283,919

(22) Filed: Oct. 30, 2002

(30) Foreign Application Priority Data
Oct. 31, 2001 (FR) 0114144

(51) Int. Cl. G06F 12/00

(52) U.S. Cl. 711/5

(57) ABSTRACT

The invention relates to a computer device for process modelling having a memory comprising, after process modelling of a user, at least one first-level process representation (A) in the form of a network formed of a plurality of interconnectable first-level tasks and a system mechanism for managing the unfolding of first-level tasks. The first-level process (A) is associated with at least one second-level process (B), each first-level task (M1) being associated with two interconnected successive second-level tasks (E1, E10). One of the two successive second-level tasks (E1) can specify a complex function undertaken by the first-level task, the other task (E10) is a constant task. The system mechanism is a single sequencer which, in order to execute a first-level task, manages at least the two associated second-level tasks (E1, E10).

The invention relates to the field of process applications.

Process representation models in the form of networks are known, for example Petri networks and GRAFCET. These networks are only used in most cases for complex industrial processes. Thus these networks are oriented towards carrying out the final process, which is executable by an algorithm which recognises the concepts developed in Petri networks and is known as a sequencer.

A problem arises if a user wants to modify a complex industrial process network, in particular due to the orientation of these networks towards the realisation of a final process. Moreover, this orientation tends to limit application to complex industrial processes.

The object of the invention is to improve the situation.

It proposes to this effect a computer device comprising a first memory comprising an arborescent structure representation, formed of a plurality of successive interconnectable modules, and a processing entity capable of working with the first memory.

According to a feature of the invention, the processing entity is capable of defining a parameter, of attributing this parameter to a given module from among the plurality of interconnectable modules and of appointing inheritance of this parameter to an interconnectable module located downstream of the given module from among the plurality of interconnectable modules.

According to another feature of the invention, the computer device comprises a compiler capable of working with the first memory in order to recover the arborescent structure and capable of recording in a second memory the parameter attributed for the given module, and this inherited parameter for the interconnectable module being located downstream of the given module.

In an advantageous embodiment of the invention, the processing entity is capable of processing a request by reading a parameter relating to an interconnectable module from the second memory.

In another advantageous embodiment of the invention, the processing entity is capable of recording in the second memory, upon request, a parameter modified with respect to an interconnectable module.

Advantageously, the processing entity is capable of appointing inheritance of the parameter to a group of interconnectable modules located downstream of the given module from among the plurality of interconnectable modules.

According to a feature of the invention, the processing entity is capable of associating with the given module a supplementary arborescent structure and of appointing inheritance of the parameter of the given module to at least part of the supplementary arborescent structure.

According to a particular feature of the invention, the parameter comprises a rule, a variable.

According to a particular embodiment of the invention, the arborescent structure is an organisation structure and the parameter comprises an organisation rule relating to a hierarchy of functions and/or a variable defining these functions.

According to a complementary embodiment of the invention, the arborescent structure is an organisation structure and the parameter comprises a variable defining responsibilities and/or responsibilities arising from functions.

According to another complementary embodiment of the invention, the arborescent structure is an organisation structure, and the parameter comprises a datum relating to a user connected to an interconnectable module of the arborescent structure.

According to an optional embodiment of the invention, the processing entity is capable of attributing a plurality of parameters to at least one given module from among the plurality of interconnectable modules.

Furthermore, the invention relates to a software product comprising a user interface suitable for working out the representation of the arborescent structure of the device according to the invention.

The invention also relates to a computer device for process modelling having a memory comprising, after modelling of a user's process, at least one first-level process representation in the form of a network formed of a plurality of interconnectable first-level tasks and a system mechanism for managing the unfolding of first-level tasks according to certain conditions.

According to a feature of the invention, the first-level process is associated with at least one second-level process, each first-level task being associated with two successive interconnected second-level tasks, one of the two successive second-level tasks being capable of specifying a complex function undertaken by the first-level task, the other task being a constant task.

According to another feature of the invention, the system mechanism is a single sequencer capable of managing at least the two associated second-level tasks in order to execute a first-level task.

In an advantageous embodiment of the invention, at least one of the two successive second-level stages specifying a complex function is associated with at least one third-level process carrying out the complex function executed by the single sequencer, the third-level process comprising at least two interconnected third-level tasks.

In another advantageous embodiment of the invention, the single sequencer is a task-executing algorithm capable of calling itself in order to execute in parallel a first task of a certain level and at least one second task associated with another level.

Advantageously, some conditions comprise the presence of an element known as a “token” associated with the state of advancement of the process.

According to a first feature of the invention, the representation of first-level processes comprises an arborescent structure of targets.

According to a particular feature of the invention, the arborescent structure of targets comprises at least one first-level task capable of being associated with at least one variable, this first-level task being associated with at least two successive interconnected tasks of the second-level process and at least one of the two tasks having as a parameter at least the said variable.

According to a complementary embodiment of the invention, the single sequencer is capable of carrying out at least the two successive second-level tasks according to at least the said variable at each task of the first-level process.

According to a further particular feature of the invention, the arborescent structure of targets comprises at least one first-level task capable of being associated with at least one rule, this first-level task being associated with at least two successive interconnected tasks of the second-level process, at least one of these tasks having for a parameter at least the said rule.

According to a complementary embodiment of the invention, the single sequencer is capable of executing, upon each task of the first-level process, at least the two successive second-level tasks according to at least the said rule.

According to an optional embodiment of the invention, in the arborescent structure of targets, certain second-level tasks specifying a complex function define one and the same complex function.

Optionally, the said one and the same complex function is designated according to a global variable turned into a parameter.

The invention also relates to a software product comprising a user interface capable of working out how to represent the process.

In an optional embodiment, the user interface has a graph editor.

In a further optional embodiment, the user interface comprises a rule editor.

Further features and advantages of the invention will appear from the detailed description below, and from the attached drawings, which show:

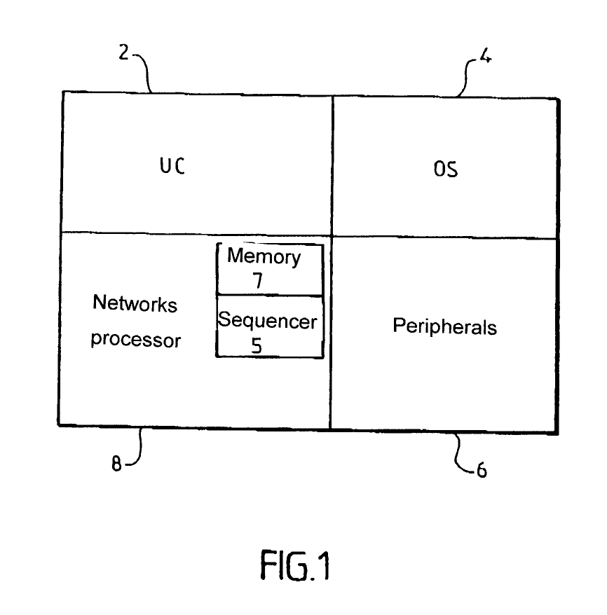

FIG. 1, a hardware environment in which the invention is embodied,

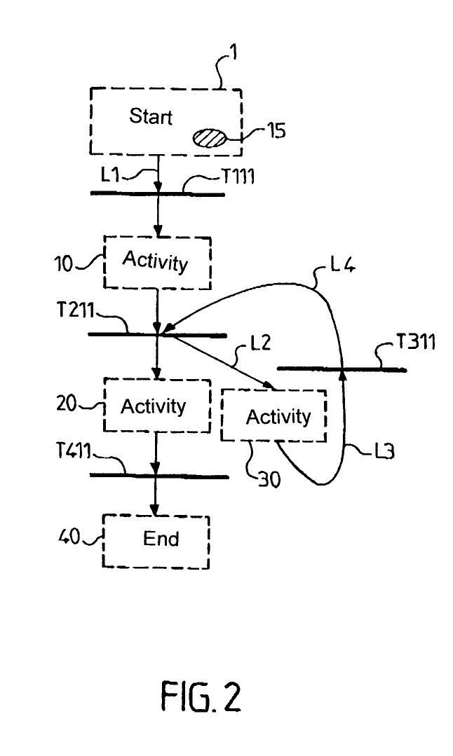

FIG. 2, a network representing a process,

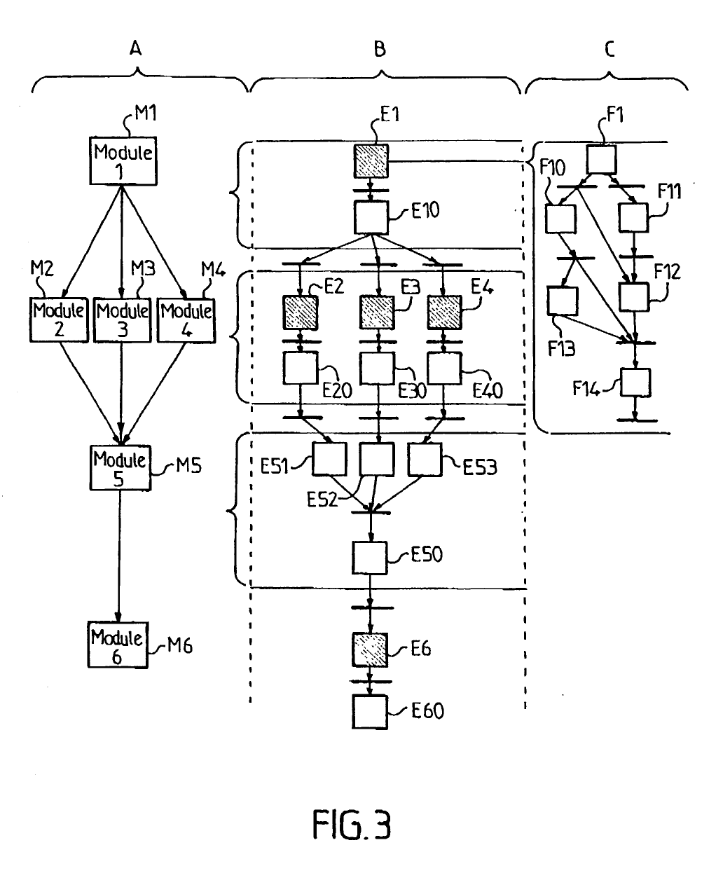

FIG. 3 shows diagrammatically a network structure representing a process according to the invention,

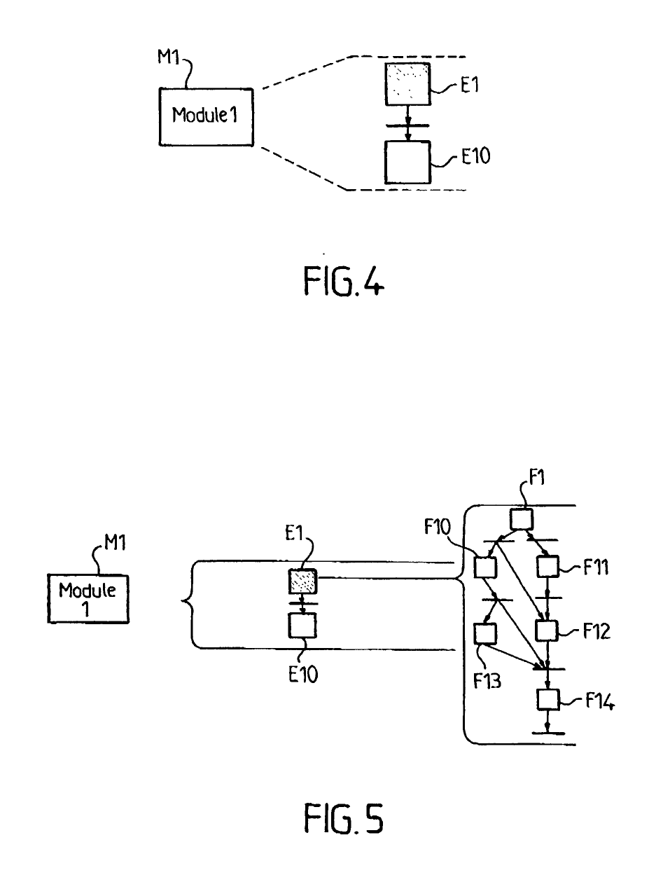

FIG. 4, a simple network form of the structure of FIG. 3,

FIG. 5, a simple network form associated with a complex network form of the structure of FIG. 3,

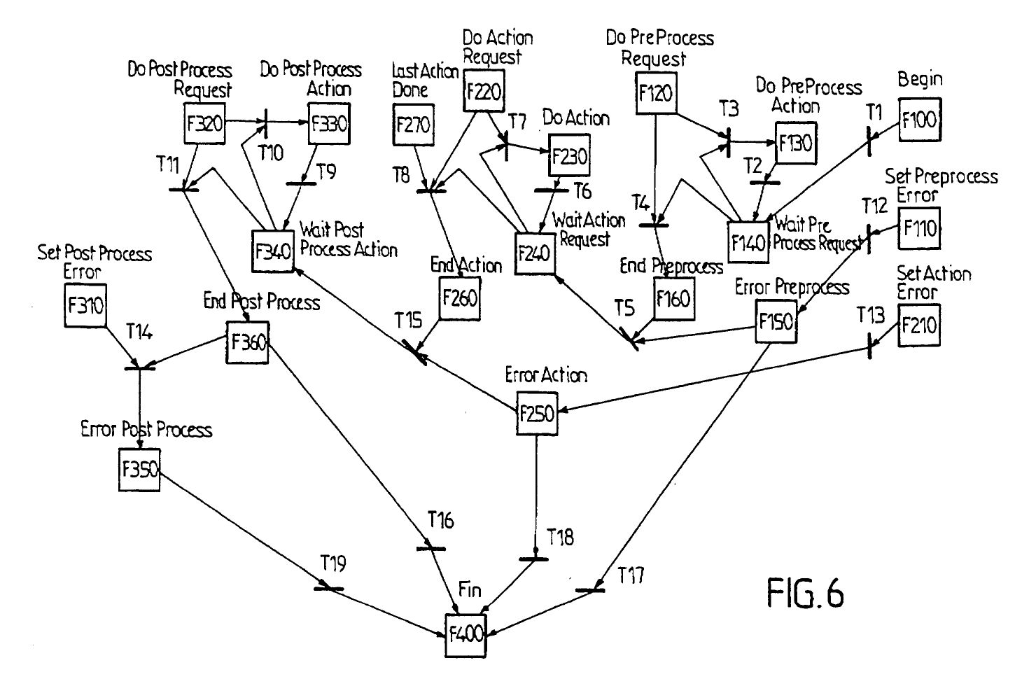

FIG. 6, an embodiment of the complex network form of FIG. 5, accompanied with labels in programming language,

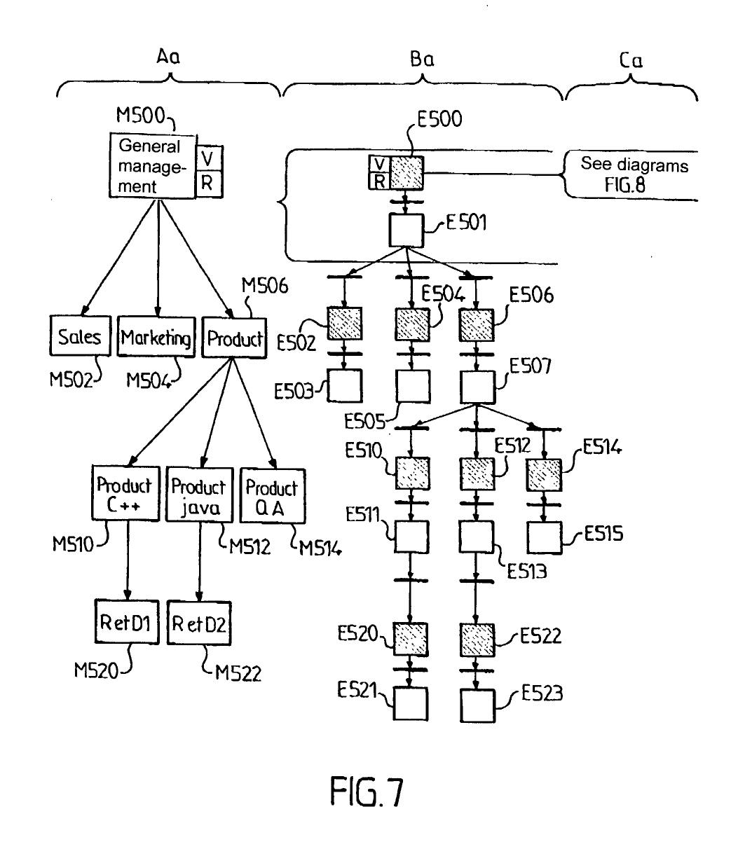

FIG. 7, an embodiment having an arborescent structure of targets according to the invention,

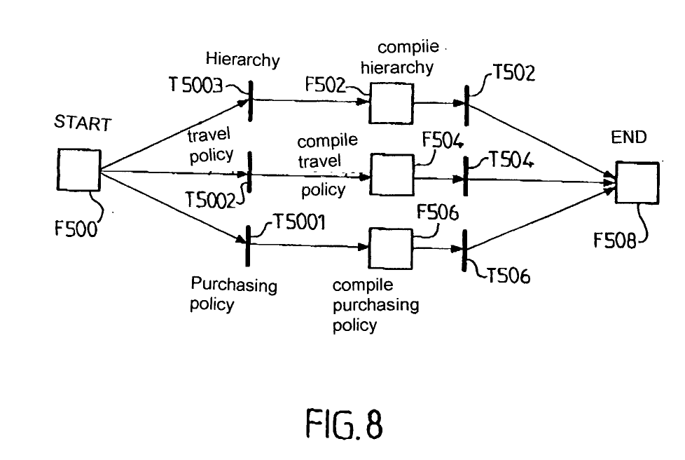

FIG. 8, an embodiment of a complex network form according to the invention,

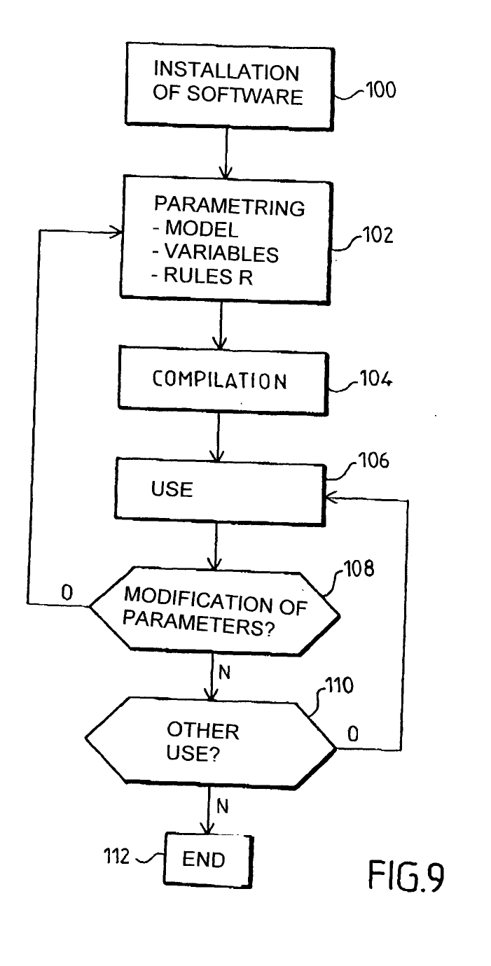

FIG. 9, a flow chart of the definition of an arborescent structure of targets to a user before use,

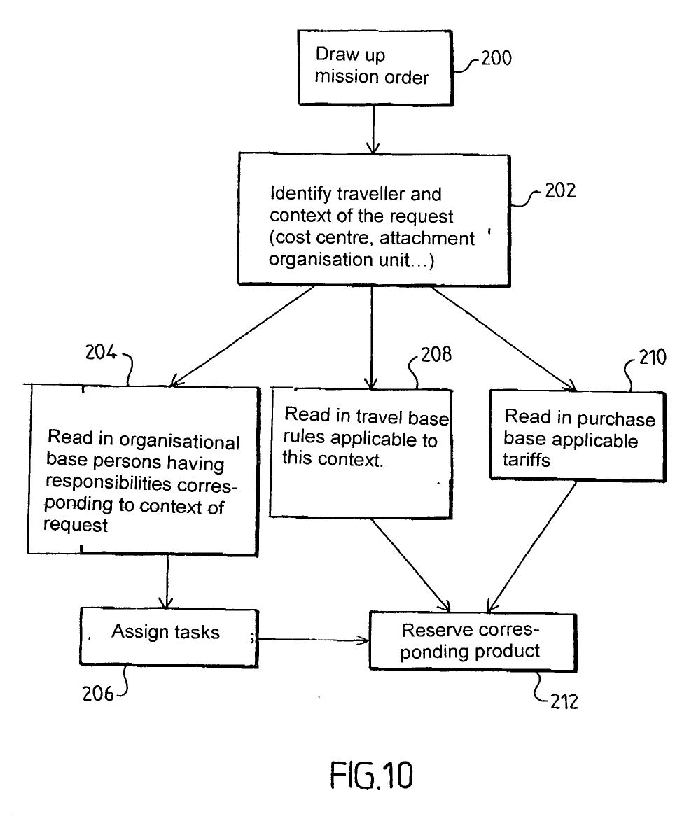

FIG. 10, a flow chart of use of the arborescent structure of targets defined according to the flow chart of FIG. 9.

The drawings contain essentially elements of a definite character. They may therefore not only serve to aid understanding of the description, but all contribute to the definition of the invention if necessary.

FIG. 1 shows a computer hardware environment comprising a central processing unit 2 connected to a working system 4, a machine for processing the networks 8 and peripherals 6. The machine for processing the networks 8 comprises software, a memory 7 having a process representation after modelling of this process, and a sequencer 5 described below according to the invention.

It is known to show processes graphically in the form of conventional networks such as the Petri network, the Grafcet network or function blocks. These models are used in particular for descriptions of complex industrial processes. As shown in FIG. 2, a hybrid representation is adopted in the course of the description, which is adaptable to conventional representations. Thus FIG. 2 shows a process representation model with concepts developed by the networks. The model is defined on the basis of various concepts:

a node, also known as a place, activity or task represents a stage of the process, e.g. the places 1, 10, 20, 30 and 40; a transition is located between two successive places;

a token 15 represents the state of advancement of the process, and the passage of the token from one place to another depends on the validity of the transitions;

a transition, also known as a condition, such as T111, T211, T311 or T411, supports a condition of passage of a token from one place to the next, this condition using variables defined on the network;

a link, e.g. L1, is a possible path between a place and a transition; a succession of links, such as L2, L3 and L4 may define a loop departing, in the example, from the same transition T2 and arriving at the same transition T2;

a variable is defined by a name and value; a local variable is limited to the network on which it is defined, a global variable is limited to a group of networks on which it is defined; the value of the variables may be modified on a place and tested on a transition.

Furthermore, logical operations can be shown, for example the operations ET as convergent, ET divergent, OU convergent, OU divergent, or OU exclusive. The representation of these operations is made by using a particular combination of links and transitions.

In the description, the term module represents an element of a graph for example. This term may also define a node (i.e. a place or a task) of a process known as first level.

FIG. 3 shows, in part A, a process in the form of a graph of modules. Each module represents part of a complex process. The graph is formed of a module M1 connected in parallel according to three distinct conditions to the modules M2, M3 and M4. These are connected according to three other distinct conditions to the module M5, itself connected, according to one condition, to the module M6.

This representation is intended for the end user, who may define or simply observe the process part connected to the modules. This representation is in particular generated by a specific editor. Each module carries out a complex function of the process.

Thus the representation of the process in the form of modules is connected to the representation of the equivalent process in the form of a simplified network according to part B of FIG. 3.

Each unit of part A is represented by two successive places connected by an equivalent transition according to part B.

Thus, according to FIG. 4, the module M1 is represented by a succession of a place E1, a transition and a place E10.

In one embodiment, E1 defines a place specifying the complex function undertaken by the corresponding module M1. The transition is still validated and the place E10 does not have a specific function, but E10 is constant.

In another embodiment, the place E1 does not have a specific function, E1 is a constant. The transition is still validated. E10 defines a place specifying the complex function undertaken by the corresponding module M1.

In FIG. 3, the modules M2, M3, M4 and M6 are each connected to the representation of the equivalent process in the form of a simplified network. Thus, for these modules, the equivalent process is shown respectively by two successive places E2 and E20, E3 and E30, E4 and E40, E6 and E60.

The module M5 defines inter alia a module of convergence between the modules M2, M3 and M4 on the one hand and the module M6 on the other.

Thus the module M5 is connected to the representation of the equivalent process in the form of a simplified network. This equivalent process is represented by the places E51, E52, and E53 in parallel connected at a transition to the place E50 so as to define a convergent logical operation ET.

A sequencer is defined as a system mechanism whereby it is possible to carry out the successive tasks of a process when it is defined in the form of a network with network concepts.

This representation, replacing all the modules with a standard equivalent in the form of a network is used in order that a sequencer can in particular execute, module by module, the defined process for the end user. This representation makes it possible to synchronise a module with its predecessors and its successors.

The shaded place E1 of the part B specifying a complex function is associated with a representation of a complex equivalent network shown in part C of FIG. 3. Thus, each shaded place E2, E3, E4 and E6 specifies a complex function associated with a complex equivalent network representation. This complex equivalent network represents the process linked to the complex function.

The example of module 1 associated with a representation of two equivalent places in the form of a simplified network is illustrated more particularly in FIG. 5. In this example, the first of the two places is associated with a complex equivalent network representation. In another embodiment, the second of the two places is associated with a complex equivalent network representation. The place associated with a complex equivalent network representation is known as “place with complex equivalence”.

Thus the place E1 is associated with a process linked to the complex function. This process comprises places F1, F10, F11, F12, F13 and F14 interconnected by transitions so as to form a process responding to the demands of the module 1. This detailed representation is used in order to specify the complex function undertaken by a module in the general execution of the process. This representation is used to calculate the internal functions of the module.

A place of the equivalent process in the form of a simplified network is advantageously a target in the sense of a target defined as target-oriented programming.

The favoured language in the rest of the description relates to targets defined in the Java programming language as in the following references:

| | |
|---|---|
| http://Java.sun.com | for Java |
| http://Java.sun.com/beans/spec.html | for JavaBeans |

and/or the corresponding printed documents, e.g. “The Java Language Specification”, J GOSLING, Bill Joy, Guy STEELE, Addison Wesley, 1996, ISBN 0-201-63451-1. However, any other target programming language can be used, such as the language C++ defined in the following reference: “The C programming language”, Brian W Kernighan, Dennis M Ritchie.

A mother class is defined with attributes and methods, in particular an execution method known as run( ) not defining parameters, and an attribute whose value signifies the presence or absence of a token. This mother class makes it possible to instance targets which are the places of the equivalent process in the form of a simplified network.

Advantageously, the places of the process linked to the complex function (part C) are defined as targets instanced from a class extended from the mother class, known as a daughter class. This daughter class inherits attributes and methods of the mother class and defines other methods and attributes peculiar to it. Moreover, each target thus instanced can use a library of data stored in a database for example. Thus the run( ) method of execution of targets instanced from the daughter class can have for a parameter methods stored in a database for example.

According to one embodiment, the system uses the algorithm defined by the sequencer to execute the places of the equivalent process in the form of a simplified network. For each place with complex equivalence whose attribute specifies the presence of a token, the sequencer is capable of calling itself in order to execute the process linked to the complex function. Thus, the sequencer is capable of executing the internal functions of each module, in particular the run( ) methods of the places defined in the process linked to the complex function.

The sequencer is defined as a recursive or re-entrant algorithm, i.e. this algorithm is capable of calling itself.

This representation of a process in three different levels (part A, part B, part C) permits a simple user description, transformed into a sequence of complex representations executable by a single standard, recursive algorithm, the sequencer. Moreover, some attributes or methods can be modified in a unique manner, the inheritance rules being applied in order to propagate modification in the various places concerned.

FIG. 6 shows an example of a network in order to carry out a particular function associated with a module from part A of FIG. 5. FIG. 6 shows a complex form (corresponding to part C of FIG. 5) of a validation process implementing a negotiation system between a caller and an executor. This process corresponds to an external algorithm allocated to the module during a configuration phase.

This processor can be associated with one of the three following phases of execution:

pre-process: automatic action executed at the start of each module,

process: programmed action at the configuration phase. This phase is adapted in particular to the user-type actions (data capture for example). A user action can use an independent connector principle which makes it possible to start up external processes, e.g. a sub-process, or an independent function.

An action may also be associated with other execution phases of the network. On the other hand, a process may consist of doing nothing. More generally, execution phases cannot define any particular action.

The pre-process starts at the place F100. After the transition T1, the place F140 makes it possible to wait for the request of the pre-process. The place F120 makes it possible to carry out the pre-process. The places F140 and F120 are both connected to transitions T3 and T4, which respectively make it possible to move to the place F130 in order to carry out the action of the pre-process, and to move on to the final place F160 in the pre-process. The place F130 is furthermore connected by a transition T2 to the place F140.

With the place F110 it is possible to determine an error that has occurred in the pre-process. This process is connected by a transition T12 to the place F150, with which it is possible to designate the error in the pre-process. This place F150 is associated with the transition T5 with the place F160. This place F150 is also associated with the transition T17 in order to arrive at the final stage F400 of the action in progress.

After the transition T5, the place F240 makes it possible to reach the request of the process. The place F220 makes it possible to carry out the process. The places F240 and F220 are both connected to the transitions T7 and T8, with which it is possible respectively to move to the place F230 in order to carry out the last process, and to move to the final place F260 in the process. A place F270, with which it is possible to determine the last action of the process, is connected to the place F260 by the transition T8. The place F230 is furthermore connected by the transition T6 to the place F240.

A place F210 makes it possible to determine an error which has occurred in the process. This place is connected by a transition T13 to the place F250, with which it is possible to designate the error in the process. This place F250 is associated with the transition T15 with the place F260. This place F250 is also associated with the transition T18 in order to reach the final stage F400 of the action in progress.

After the transition T15, the place F340 makes it possible to reach the request of the post-process. The place F320 makes it possible to carry out the post-process. The places F340 and F320 are both connected to the transitions T10 and T11, which make it possible respectively to move to the place F330 in order to carry out the action of the post-process and to move on to the final place F360 in the post-process. The place F330 is furthermore connected by a transition T9 to the place F340.

With a place F310, it is possible to determine an error which has occurred in the post-process. This place is connected by a transition T14 to the place F350, with which it is possible to designate the error in the post-process. The place F360 is also connected by the transition T14 to the place F350. This place F350 is associated with the transition T19 in order to reach the final stage F400 of the action in progress. The place F360 is also associated with the transition T16 in order to reach the stage F400.

An embodiment of the invention is shown in FIGS. 7 to 10. This embodiment has an application of the elements described above for setting up an arborescent structure of targets. In the embodiment described, the arborescent structure of targets is applied to a business.

FIG. 7 shows an arborescent structure of targets Aa with which it is possible to define, in the form of modules, the hierarchical structure of the business.

Thus the module M500 represents the module of general management connected to the modules of the sales M502, marketing M504 and production M506 service. The module of production service is itself connected to the modules of service of the C++ product M510, of the Java product M512, and of the QA product M514. The module of service of the C++ product M510 is connected to the module of service Research and Development 1 M520. The module of +service of the product Java M521 is connected to the module of service Research and Development 2 M522. Each module is connected to the following module depending on a condition of passage.

The arborescent structure of targets Aa is associated with a standard equivalent structure in the form of a network Ba. Thus, as described above, the module M500 is associated with a standard equivalent in the form of a network consisting of two successive places E500 and E501 connected by a transition. The module M502, M504 and M506 are each associated with a standard equivalent in the form of a network consisting of two successive places, respectively E502 and E503, E504 and E505, E506 and E507, interconnected by a transition.

The modules M510, M512 and M514 are each associated with a standard equivalent in the form of a network consisting of two successive places, respectively E510 and E511, E512 and E513, E514 and E515, interconnected by a transition. The module M520 is associated with a standard equivalent in the form of a network consisting of two successive places E520 and E521, connected by a transition. The module M522 is associated with a standard equivalent in the form of a network consisting of two successive places E522 and E523 connected by a transition.

Each set of two successive places connected by a transition is connected to the following set by a transition corresponding to the condition of passage between one module and the next. Thus the sequencer can reach a place with complex equivalence if the upstream transition is valid.

In an advantageous embodiment, variables V are associated with at least certain modules, e.g. M500 and with the associated place with complex equivalence, e.g. E500. These variables V are for example attributes in the target case (in the sense of target-oriented programming). These variables V can be definitions of functions applicable in the business, definitions of responsibilities, or definitions of teams.

In another embodiment, rules R are associated with at least certain modules, e.g. M500, and with the associated place of complex equivalence, e.g. E500. These rules, defined more fully below, may comprise rules of organisation concerning the hierarchy of functions, and of responsibilities arising from functions.

In the embodiment proposed, each place with complex equivalence is associated with one and the same complex equivalent network representing the process linked to the complex function Ca.

FIG. 8 shows the complex equivalent network of the example of FIG. 7. Thus the place F500 represents the start of the process. The transitions T5003, T5002, and T5001 in parallel make it possible to orient the sequencer respectively towards a hierarchy compilation place F506, a journey policy compilation place F504, and a purchase policy compilation place F502. Once execution of the place F502, F504 or F506 is finished, the transitions T502, T504, and T506 make it possible to authorise the end of the process on a place F508.

Once the sequencer is underway, certain parameters are defined, such as a parameter for selecting between execution of a hierarchical structure compilation, execution of a journey policy compilation, and an execution of a purchase policy compilation. In one embodiment of the invention, this parameter is a global variable.

Thus the sequencer is oriented towards one of the three executions for each place with complex equivalence as a function of this global variable.

FIG. 9 shows a flow chart of the setting up on the premises of a user of a tool for determining an organisational structure according to an embodiment of the invention. This tool comprises a motor, a configurer for defining the structure, variables, rules (methods and attributes of the targets) and a database. The configurer has a graph editor for defining the organisational structure, certain variables and a rule editor for defining the rules. The motor comprises the sequencer and connectors.

A connector may be defined as an interface for the execution for example of a process, wherein execution may be synchronous or asynchronous.

The tool is first of all installed in stage 100 on the premises of the user. With the stage 102 it is possible to create a hierarchical organisational structure in the embodiment shown. The example of an organisational structure is given for a travel business. Thus an organisational model is first created via a graphic tool known as a graph editor. The associated models and places of the model are also known as organisation units. An entity to be organised is defined as a set of organisation units having a common transverse dimension. The hierarchical arborescent structure is created and defined differently for each entity of the business to be organised. A set of variables V, such as defined above, is associated with at least some of the organisation units.

A set of rules R is associated with at least some of the organisation units by the rules editor. These rules R comprise for example

journey policy rules relating to products, itineraries, the organisational model, the user profile, operators, and travel conditions;

rules of purchasing policy relating to the products, tariffs, resetting backwards and forwards, the evolution of resets, the accumulation of resets, conditions for access thereto, with parameters and objectives.

These rules R and variables V also depend on the organisation units being considered.

In the case of organisation units which do not have rules and/or directly associated variables, principles of inheritance are applied. In other words, these organisation units inherit rules and/or variables of the organisation units upstream in the model.

In the rest of the description, the term compilation means that the motor writes in a database or under any other format the parameters corresponding to the compilation requested.

Once these parameters formed by the organisational model, the rules and variables have been defined, stage 104 makes it possible to compile. Thus, as proposed in FIG. 8, a compilation choice parameter makes it possible to carry out either compilation of the organisational model, or the compilation of a purchasing policy. Advantageously, the three compilations are carried out consecutively. The sequencer makes it possible, as described above, to carry out the complex equivalent process defining the possible compilations.

The compilation of the organisational model implies recording of data relating to organisational units and users concerned, the ties of responsibility and hierarchies, and this according to the entity to be organised. The compilation of a travel policy implies the recording of data relating to the applicable travel rules on each organisation unit and this according to the entity to be organised.

In stage 106, a user may, upon request, use the organisational structure in order to obtain information released without calculation, e.g. read in a base or in any other format.

At stage 108, the parameters can be modified on demand by a user. The process returns to stage 102 in order to redefine certain parameters and then to carry out compilation appropriate to the modification of parameters.

If the parameters are not modified, the user has the choice of reusing the organisational structure or not at stage 110. If this is used, the process picks up again from stage 106. In the opposite case, the process is ended at stage 112.

FIG. 10 shows more particularly the use of the organisational structure from stage 106 of FIG. 9 by an employee wanting to make a journey.

Thus, the user is led to draw up a request, also known as a mission order, at stage 200. The employee is identified as well as the context of the request at stage 202.

In part of the base containing the organisational structure, the motor reads the variables defining the name of the persons having responsibility corresponding to the request at stage 204. Decision-taking is assigned to these persons at stage 206.

In parallel with stage 204, in another part of the base containing the rules applicable to the travel policy, the motor reads the variables defining the travel rules corresponding to the request at stage 208.

In parallel with stage 208, in a different part of the base containing the rules applicable to the purchasing policy, the motor reads the variables defining the purchasing rules corresponding to the request at stage 210.

After tasks 208, 210 and 206, stage 212 allows the product to be reserved, in this case the journey, corresponding to the request of stage 200.

Obviously, the invention is not limited to the embodiment described above by way of example, but also extends to other modifications.

The object of the invention can be realised in the field of a software application. It may be realised to be sold as an independent unit to be integrated in a software product, e.g. sold to software integrators or editors.

1. Computer device comprising a first memory (7) comprising an arborescent structure representation formed of a plurality of successive interconnectable modules (M500, M506, M510) and a processing entity (8) capable of working with the first memory, characterised in that the processing entity (8) is capable of defining a parameter, of attributing this parameter to a given module from among the plurality of interconnectable modules and of appointing inheritance of this parameter to an interconnectable module located downstream of the given module from among the plurality of interconnectable modules.

2. Computer device according to claim 1, characterised in that it comprises compiling means capable of working with the first memory in order to recover the arborescent structure and capable of recording in a second memory the parameter attributed for the given module, and this inherited parameter for the interconnectable module being located downstream of the given module.

3. Computer device according to claims 1 and 2, characterised in that the processing entity is capable of processing a request by reading a parameter relating to an interconnectable module in the second memory.

4. Computer device according to claim 3, characterised in that the processing entity is capable of recording in the second memory, upon request, a modified parameter relative to an interconnectable module.

5. Computer device according to one of claims 1 to 4, characterised in that the processing entity is capable of appointing inheritance of the parameter to a group of interconnectable modules located downstream of the given module from among the plurality of interconnectable modules.

6. Computer device according to one of claims 1 to 5, characterised in that the processing entity is capable of associating with the given module a supplementary arborescent structure and of appointing inheritance of the parameter of the given module to at least part of the supplementary arborescent structure.

7. Computer device according to one of claims 1 to 6, characterised in that the parameter comprises a rule (R).

8. Computer device according to one of claims 1 to 7, characterised in that the parameter comprises a variable (V).

9. Computer device according to one of claims 1 to 8, characterised in that the arborescent structure is an organisation structure and in that the parameter comprises an organisation rule relating to a hierarchy of functions and/or a variable defining these functions.

10. Computer device according to one of claims 1 to 9, characterised in that the arborescent structure is an organisation structure and in that the parameter comprises a variable defining responsibilities and/or responsibilities arising from functions.

11. Computer device according to one of claims 1 to 10, characterised in that the arborescent structure is an organisation structure and in that the parameter comprises a datum relating to a user connected to an interconnectable module of the arborescent structure.

12. Computer device according to one of claims 1 to 11, characterised in that the processing entity is capable of attributing a plurality of parameters to at least one given module from among the plurality of interconnectable modules.

13. Software product comprising a user interface suitable for working out how to represent the arborescent structure of the device according to claims 1 to 12.

14. Software product according to claim 13, characterised in that the user interface comprises a graph editor.

15. Software product according to either of claims 13 or 14, characterised in that the user interface comprises a rules editor.

16. Computer device for modelling processes comprising a memory having, after modelling of processes of a user, at least one first-level process representation (A) in the form of a network formed of a plurality of interconnectable first-level tasks and a system mechanism for managing the unfolding of the first-level tasks according to certain conditions, characterised in that the first-level process (A) is associated with at least one second-level process (B), each first-level task (M1) being associated with two successive, interconnected second-level tasks (E1, E10), one of the two successive second-level tasks (E1) being capable of specifying a complex function undertaken by the first-level task (M1), the other task (E10) being a constant task, and in that the system mechanism is a single sequencer (5) capable of managing for the execution of a first-level task (M1) at least the two associated second-level tasks (E1, E10).

17. Computer device for modelling processes according to claim 1, characterised in that at least one of the two successive second-level stages specifying a complex function (E1) is associated with at least one third-level process (C) effecting the complex function executed by the single sequencer (5), the said third-level process (C) comprising at least two interconnected third-level tasks (F1, F11).

18. Computer device for modelling processes according to either of claims 1 or 2, characterised in that the single sequencer (5) is an algorithm for executing tasks which is capable of calling itself in order to execute in parallel a first task of a certain level (M1) and at least one associated second task of another level (E1, E10).

19. Computer device for modelling processes according to one of the preceding claims, characterised in that certain conditions comprise the presence of an element known as a “token” associated with the state of advancement of the process.

20. Computer device for modelling processes according to one of claims 1 to 4, characterised in that the first-level process representation (A) comprises an arborescent structure of targets (Aa).

21. Computer device for modelling processes according to one of claims 1 to 4, characterised in that the arborescent structure of targets (Aa) comprises at least one first-level task (M500) capable of being associated with at least one variable (V), this first-level task (M500) being associated with at least two interconnected successive tasks (E500, E501) of the second level process (Ba), at least one of the two tasks having as a parameter at least the said variable (V) and in that the single sequencer (5) is capable of executing at each task of the first-level process (M500) at least the two successive tasks (E500, E501) of the second level (Ba) according at least to that variable (V).

22. Computer device for modelling processes according to one of claims 5 or 6, characterised in that the arborescent structure of targets (Aa) comprises at least one first-level task (M500) capable of being associated with at least one rule (R), this first-level task being associated with at least two interconnected successive tasks (E500, E501) of the second-level process (Ba), at least one of the two tasks having as a parameter at least the said rule (R) and in that the single sequencer (5) is capable of executing at each task of the first-level process (M500) at least the two successive second-level tasks (E500, E501) according at least to the said rule (R).

23. Computer device for modelling processes according to one of claims 5 to 7, characterised in that, in the arborescent structure of targets, certain second-level tasks specifying a complex function (Ca) define one and the same complex function (Ca).

24. Computer device for modelling processes according to claim 8, characterised in that the same complex function (Ca) is designated according to a global variable which has turned into a parameter.

25. Software product comprising a user interface suitable for drawing up the representation of processes of the device according to one of claims 1 to 9.

26. Software product according to claim 10, characterised in that the user interface comprises a graph editor.

27. Software product according to one of claims 10 or 11, characterised in that the user interface comprises a rules editor.
